(19) United States
(12) Patent Application Publication
(10) Pub. No.: US 2007/0157904 A1
(43) Pub. Date: Jul. 12, 2007

(54) Device for monitoring the fuel pressure in the fuel supply circuit for an internal combustion engine with fuel injection

(75) Inventors: Alain Aubourg, Saint-Jean (FR); Patrice Mallejac, Plougastel Daoulas (FR)

Correspondence Address: YOUNG & THOMPSON, 745 SOUTH 23RD STREET, 2ND FLOOR, ARLINGTON, VA, 22202, US

(73) Assignee: SIEMENS VDO AUTOMOTIVE, Toulouse Cedex 1 (FR)

(21) Appl. No.: 10/589,854

(22) PCT Filed: Feb. 1, 2005
(86) PCT No.: PCT/EP05/00964

§ 371 Date: Aug. 17, 2006

(30) Foreign Application Priority Data
Feb. 18, 2004 (FR) 0401595

(51) Int. Cl. F02M 65/00; F02M 69/54; G01M 15/00

(52) U.S. Cl. 123/457; 73/119 A; 123/479

(57) ABSTRACT

A device for monitoring the fuel pressure in the fuel feed circuit (7) of a fuel injection internal combustion engine (2), which includes at least one cylinder (2) and one exhaust line (6) for the combustion gases, characterized in that the device includes elements (8) for generating a value for measuring the fuel/air ratio of the exhaust gases in the exhaust line (6), elements (9) for generating a value for measuring the fresh air flow rate into the cylinder (2), elements (10) determining the mechanical opening time of the injector (4), and computation elements (1) for determining a reconstituted fuel pressure value from the value for measuring the fuel/air ratio of the exhaust gases, from the value for measuring the fresh air flow rate and from the mechanical opening time of the injector.

The present invention relates to a device for monitoring the fuel pressure in the fuel feed circuit of a fuel injection internal combustion engine.

In the known devices as described, for example, in patents U.S. Pat. No. 6,032,639 and U.S. Pat. No. 6,138,638, the fuel pressure in the fuel feed circuit of injection internal combustion engines is generally measured by a pressure sensor. The value of this pressure is converted into an electrical signal which is used by a computer that manages the engine operating control units.

Such pressure sensors are always present in direct injection engines. In such direct injection engines, in case of failure of the pressure sensor, it detects a pressure that is either lower or higher than the real pressure, which can cause improper operation of the engine, or breakdown thereof.

In certain indirect injection internal combustion engines, no fuel pressure sensor is provided, so that the engine operation is controlled without taking account of fuel pressure variations.

It is the object of the present invention to provide a device for monitoring the fuel pressure in the fuel feed system of an internal combustion engine, which can remedy any failure of the fuel pressure sensor when such a sensor is present, or substitute for such a sensor to ensure the optimal operation of the internal combustion engine.

For this purpose, the subject of the invention is a device for monitoring the fuel pressure in the fuel feed circuit of a fuel injection internal combustion engine, which comprises at least one cylinder and one exhaust line for the combustion gases, said device comprising

means for generating a value for measuring the fuel/air ratio of the exhaust gases in said exhaust line,

means for generating a value for measuring the fresh air flow rate into said cylinder,

means determining the mechanical opening time of the injector of said cylinder, and

computation means for determining a reconstituted fuel pressure value from said value for measuring the fuel/air ratio of the exhaust gases, from said value for measuring the fresh air flow rate and from said mechanical opening time of the injector.

A further object of the invention is a method for monitoring the fuel pressure in the fuel feed circuit of a fuel injection internal combustion engine, which comprises at least one cylinder and one exhaust line for the combustion gases, comprising the following steps:

generation of a value for measuring the fuel/air ratio of the exhaust gases in said exhaust line,

generation of a value for measuring the fresh air flow rate into said cylinder,

determination of the mechanical opening time of said injector, and

determination of a reconstituted fuel pressure value from said value for measuring the fuel/air ratio of the exhaust gases, from said value for measuring the fresh air flow rate and from said mechanical opening time of said injector.

The method according to the invention may further comprise one or more of the following steps:
determination of the value of the mass of fuel injected from said value for measuring the fuel/air ratio of the exhaust gases and from said value for measuring the fresh air flow rate, determination of the value of the static flow rate of the injector as a function of said value of the mass of fuel injected and of said mechanical opening time of the injector, and determination of said reconstituted pressure value from said static flow rate of the injector and from the value of the pressure near the injector nozzle;
determination of said mechanical opening time of the injector from the electrical control time d1 of the injector, from the time interval d2 necessary for the mechanical opening of the injector, and from the time interval d3 necessary for the mechanical closing of the injector, according to the equation d=d1−d2+d3;
generation of a value for measuring the fuel pressure in said fuel feed circuit and making of a diagnosis of the operating status of said pressure sensor from the result of the comparison between said value for measuring the fuel pressure taken by said sensor and said reconstituted fuel pressure value;
detection of the drifts of the reconstituted fuel pressure value and/or of the value for measuring the fuel pressure and making of a diagnosis of the status of said fuel feed circuit from said drifts.

Other features and advantages of the invention will further appear throughout the description below.

In the appended drawings, provided as nonlimiting exemplary embodiments:

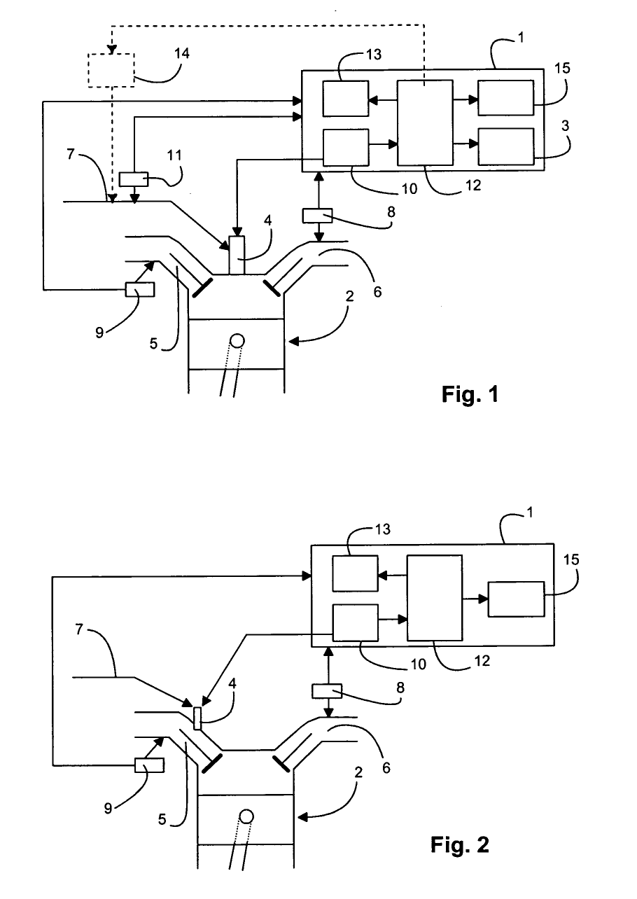

FIG. 1 is a simplified diagram of the device according to the invention in the case of a direct injection fuel feed system comprising a pressure sensor;

FIG. 2 is a simplified diagram of the device according to the invention in the case of an indirect injection fuel feed system, without a pressure sensor;

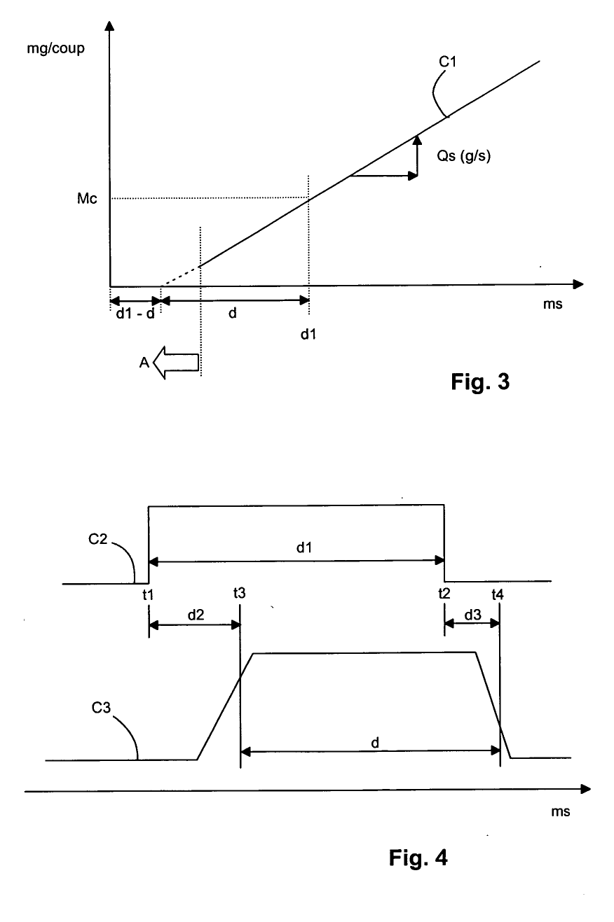

FIG. 3 is a representation of the variation in the quantity of fuel delivered by the injector as a function of the electrical control time of the injector, for illustrating the mode for computing certain parameters used in the invention; and

FIG. 4 is a representation as a function of time of the electrical control signal of the injector and of the position of the injector needle, for illustrating the mode for computing certain parameters used in the invention.

FIGS. 1 and 2 show a device for monitoring the fuel feed circuit of an engine, in which, for the sake of simplification, a single cylinder 2 is shown with its associated injector 4. In a known manner, such a monitoring device comprises a computer 1 which determines the optimal operating parameters of the internal combustion engine from data measured by various sensors.

The computer 1 comprises means 10 for controlling the injectors which determine the control parameters of each injector 4, particularly the electrical control time of the injector, which is the control time of the electrical actuating member, for example, the coil, of each injector.

In FIGS. 1 and 2, the numeral 5 denotes the air intake line in the combustion chamber of the cylinder 2 and numeral 6 denotes the exhaust line for the combustion gases. Numeral 7 denotes the fuel feed circuit which feeds the cylinder 2 via the injector 4.

In the case of FIG. 1, the fuel is injected directly into the combustion chamber by the injector 4. In the case of FIG. 2, injection is indirect and the fuel is injected into the intake manifold 5.

According to the invention, the device for monitoring the fuel pressure in the fuel feed circuit of the internal combustion engine comprises means 8 for measuring the fuel/air ratio of the exhaust gases and means 9 for measuring the fresh air flow rate into the cylinder 2.

The means 8 for measuring the fuel/air ratio of the exhaust gases are, for example, provided in the form of an oxygen probe, delivering a signal (an analog voltage) that is a function of the oxygen content, a content from which the fuel/air ratio of the exhaust gases can be determined.

The means 9 for measuring the fresh air flow rate into the cylinder 2, are provided, for example, in the form of a mass air flowmeter or in the form of a pressure sensor delivering a measurement of the air pressure from which the air flow rate can be calculated taking account of the engine speed.

The monitoring device further comprises computation means 12 for calculating the real fuel pressure from the measurements taken by said means 8 and 9, and from the mechanical opening time of the injector. In fact, as described in greater detail below, a fuel pressure value in the fuel feed circuit is calculated from the value for measuring the fuel/air ratio of the exhaust gases, from the value for measuring the fresh air flow rate into the cylinder, and from the mechanical opening time of the injector.

The computation means 12 thus comprise:
means for determining the value of the mass of fuel injected from the value for measuring the fuel/air ratio of the exhaust gases and from the value for measuring the fresh air flow rate into the cylinder,
means for determining the value of the static flow rate of the injector as a function of the value of the mass of fuel injected and of the mechanical opening time of the injector,
means for determining the reconstituted pressure value from said static flow rate of the injector and from the value of the pressure near the injector nozzle.

The mathematical equations linking these various parameters and which are used for implementing the invention are, for example, equations (1), (2), (3) and (4) given below:

$$M c = Ri \frac{Ma}{14.7} \qquad ( 1 )$$

where Mc is the mass of fuel injected (in mg/stroke), Ri is the measurement of the fuel/air ratio in the exhaust gases, and Ma is the fresh air flow rate into the cylinder (in mg/stroke), 14.7 being the Ma/Mc ratio for a stoichiometric mixture (Ri=1);

$$Qs = \frac{M c}{d} \qquad ( 2 )$$

where Qs is the static flow rate of the injector (in g/s), d is the mechanical opening time of the injection (in ms) and Mc is the mass of fuel injected (in mg/stroke);

$$\begin{matrix}\frac{Qs}{Qs 0} = \sqrt{\frac{Pc - P a}{Δ P 0}} \\ or even ; & ( 3 ) \\ Pc = [ {( \frac{Qs}{Qs 0} )}^{2} \times Δ P 0 + P a ] & ( 4 )\end{matrix}$$

where Pc is the reconstituted pressure value (in bar), Qs is the static flow rate of the injector (in g/s), and Pa is the value of the pressure near the injector nozzle (in bar), Qs0 being the nominal static flow rate of the injector (in g/s) for a nominal value ΔP0 of the difference between the fuel pressure and the pressure near the injector nozzle (in bar).

The value Pa of the pressure near the injector nozzle may, for example, be determined by measurement using a sensor, which may be the same as the one used to determine the air flow rate into the engine.

FIG. 3 shows the curve of variation C1 of the quantity of fuel Mc (in mg/stroke) delivered by the injector as a function of the electrical control time d1 (in ms), for a constant value of the difference between the fuel pressure and the air pressure near the injector nozzle. This curve of variation C1 is essentially a line of which the slope Qs represents the static flow rate of the injector (in g/s). However, for low values of d1, the curve has a nonlinear part A, not shown. The prolongation of the linear part intersects the x axis at a point that has the value d1−d, where d is the mechanical opening time of the injector shutter. The slope Qs is thereby determined from d and from Mc by the equation (2) given above.

When the injector is actuated, many parameters determine the mechanical opening time d of the injector. This mechanical opening time of the injector is the time during which the injector shutter (for example injector needle) is in the maximum or virtually maximum open position (the needle is at the mechanical stop). FIG. 4 shows the computing mode for this value d. FIG. 4 comprises a first curve C2 representing the variation in time of the electrical control signal of the injector and a second curve C3 representing the variation in time of the position of the injector needle.

The mechanical opening time d of the injector depends on the following parameters:
the electrical control time d1 of the injector, that is, when the electrically actuating member of the injector is a coil, the time interval elapses between time t1 of energization of the injector coil and time t2 of deenergization of the injector coil,
the time interval d2 necessary for the mechanical opening of the injector, that is, when the mechanical shutter of the injector is a needle and the electrically actuating member of the injector is a coil,
the time interval between time t1 of energizing the injector coil and time t3 in which the needle is effectively open; this time interval depends on the speed of opening of the injector shutter and a dead time existing between time t1 and the actual start of mechanical opening of the shutter;
the time interval d3 necessary for mechanical closing of the injector, that is, when the mechanical shutter of the injector is a needle and the electrically actuating member of the injector is a coil, the time interval between time t2 of deenergization of the injector coil and time t4 in which the needle is actually closed; this time interval depends on the speed of closure of the injector shutter and a dead time existing between time t2 and the actual start of mechanical closure of the shutter.

Preferably, the mechanical opening time of the injector shutter is determined by computation means 12 from d1, d2, and d3 using the following formula:
d=d1−d2+d3=(t2−t1)−(t3−t1)+(t4−t2)=t4−t3,
where d1 is obtained by the computation means 12 from the control means 10 which have generated it,
d2 and d3 are predefined fixed values or variable values as a function of certain parameters (the battery voltage, for example, measurable by the computer) and are read or reconstituted from values stored in a table or a memory associated with the computation means 12.

The device shown in FIG. 1 further comprises a sensor 11 for measuring the fuel pressure in the fuel feed circuit 7 and means, for example forming part of the computer 1, for comparing the pressure measurement taken by the sensor 11 with the reconstituted pressure value determined by the computation means 12.

In this embodiment with sensor 11, the result of the comparison is used by diagnosis means 3 to make a diagnosis of the operating status (proper operation or failure) of said pressure sensor 11. By contrast with the direct injection device shown in FIG. 1, the indirect injection device shown in FIG. 2 comprises neither pressure sensor nor diagnosis means of the pressure sensor.

According to a particular embodiment, the computer 1 further comprises means 13 for initiating a fallback operating mode, when the calculated value of the fuel pressure is higher, respectively lower, than a maximum, respectively minimum predefined threshold value. These threshold values are predefined, for example, from the operating safety requirements.

According to a particular embodiment, the device according to the invention comprises regulating means 14 for adjusting the pressure from said reconstituted pressure value. The regulation in this embodiment takes place in an open loop. The regulating means are preferably made in this case in the form of an electrical controller. In such an embodiment, according to an advantageous feature, the reconstituted pressure value is determined only in predefined engine operating zones in order to guarantee the reliability of the pressure data thus obtained. These zones are virtually stabilized operating zones for which the variations in engine speed and intake air pressure are slow. This embodiment can apply, for example, in case of absence of a pressure sensor 11 or in case of malfunction thereof. In the latter case, the diagnosis means 3 of the sensor, the means 13 for initiating a fallback operating mode, can effectively cooperate with the regulating means 14.

According to a particular embodiment, the device according to the invention comprises means for detecting (for example by the computation means 12) rapid drifts of the reconstituted fuel pressure value and/or of the value of the fuel pressure measurement delivered by the sensor 11 and comprises means 15 for making a diagnosis of the status of the fuel feed circuit 7 from said drifts. A problem of connection or blocked piping can thereby be detected.

1. A device for monitoring the fuel pressure in the fuel feed circuit (7) of a fuel injection internal combustion engine (2), which comprises at least one cylinder (2) and one exhaust line (6) for the combustion gases, characterized in that said device comprises
means (8) for generating a value for measuring the fuel/air ratio of the exhaust gases in said exhaust line (6),
means (9) for generating a value for measuring the fresh air flow rate into said cylinder (2),
means (10, 12) determining the mechanical opening time of the injector (4) of said cylinder (2), and
computation means (12) for determining a reconstituted fuel pressure value from said value for measuring the fuel/air ratio of the exhaust gases, from said value for measuring the fresh air flow rate and from said mechanical opening time of the injector (4).

2. The device as claimed in claim 1, characterized in that it comprises,
means (12) for determining the value of the mass of fuel injected from said value for measuring the fuel/air ratio of the exhaust gases and from said value for measuring the fresh air flow rate,
means (12) for determining the value of the static flow rate of the injector as a function of said value of the mass of fuel injected and of said mechanical opening time of the injector,
means (12) for determining said reconstituted pressure value from said static flow rate of the injector and from the value of the pressure near the injector nozzle.

3. The device as claimed claim 1, characterized in that it comprises means (12) for determining said mechanical opening time of the injector from the electrical control time d1 of the injector, from the time interval d2 necessary for the mechanical opening of the injector, and from the time interval d3 necessary for the mechanical closing of the injector, according to the equation d=d1−d2+d3.

4. The device as claimed in claim 1, characterized in that it comprises
a sensor (11) for measuring the fuel pressure in said fuel feed circuit (7),
means (12) for making a comparison between the value for measuring the fuel pressure taken by said sensor (11) and said reconstituted fuel pressure value and
means (3) for making a diagnosis of the operating status of said pressure sensor (11) from the result of said comparison.

5. The device as claimed in claim 1, characterized in that it comprises means (13) for initiating a fallback operating mode, when said reconstituted fuel pressure value is higher, respectively lower, than a predefined maximum, respectively minimum, threshold value.

6. The device as claimed in claim 1, characterized in that it comprises means (14) for adjusting the pressure from said reconstituted pressure value.

7. The device as claimed in on of claims 1 to 6 claim 1, characterized in that it comprises
means (12) for detecting drifts of the reconstituted fuel pressure value and/or of the value for measuring the fuel pressure and
means (15) for making a diagnosis of the status of said fuel feed circuit (7) from said drifts.

8. A method for monitoring the fuel pressure in the fuel feed circuit (7) of a fuel injection internal combustion engine (2), which comprises at least one cylinder (2) and one exhaust line (6) for the combustion gases, characterized in that it comprises the following steps:
generation of a value for measuring the fuel/air ratio of the exhaust gases in said exhaust line (6),
generation of a value for measuring the fresh air flow rate into said cylinder (2),
determination of the mechanical opening time of the injector, and
determination of a reconstituted fuel pressure value from said value for measuring the fuel/air ratio of the exhaust gases, from said value for measuring the fresh air flow rate and from said mechanical opening time of the injector.

9. The method as claimed in claim 8, characterized in that said method further comprises the following steps:
determination of the value of the mass of fuel injected from said value for measuring the fuel/air ratio of the exhaust gases and from said value for measuring the fresh air flow rate,
determination of the value of the static flow rate of the injector as a function of said value of the mass of fuel injected and of said mechanical opening time of the injector,
determination of said reconstituted pressure value from said static flow rate of the injector and from the value of the pressure near the injector nozzle.

10. The method as claimed in claim 8, in that it further comprises the step for determining said mechanical opening time of the injector from the electrical control time d1 of the injector, from the time interval d2 necessary for the mechanical opening of the injector, and from the time interval d3 necessary for the mechanical closing of the injector, according to the equation d=d1−d2+d3.

11. The method as claimed in claim 8, characterized in that it further comprises the following steps:
generation of a value for measuring the fuel pressure in said fuel feed circuit (7),
making of a diagnosis of the operating status of said pressure sensor (11) from the result of the comparison between said value for measuring the fuel pressure taken by said sensor (11) and said reconstituted fuel pressure value.

12. The method as claimed in claim 8, in that it further comprises the following steps:
detection of drifts of the reconstituted fuel pressure value and/or of the value for measuring the fuel pressure
making of a diagnosis of the status of said fuel feed circuit from said drifts.

13. The method as claimed in claim 9, in that it further comprises the step for determining said mechanical opening time of the injector from the electrical control time d1 of the injector, from the time interval d2 necessary for the mechanical opening of the injector, and from the time interval d3 necessary for the mechanical closing of the injector, according to the equation d=d1−d2+d3.

14. The method as claimed in claim 9, characterized in that it further comprises the following steps:
generation of a value for measuring the fuel pressure in said fuel feed circuit (7),
making of a diagnosis of the operating status of said pressure sensor (11) from the result of the comparison between said value for measuring the fuel pressure taken by said sensor (11) and said reconstituted fuel pressure value.

15. The method as claimed in claim 10, characterized in that it further comprises the following steps:
generation of a value for measuring the fuel pressure in said fuel feed circuit (7),
making of a diagnosis of the operating status of said pressure sensor (11) from the result of the comparison between said value for measuring the fuel pressure taken by said sensor (11) and said reconstituted fuel pressure value.

16. The device as claimed claim 2, characterized in that it comprises means (12) for determining said mechanical opening time of the injector from the electrical control time d1 of the injector, from the time interval d2 necessary for the mechanical opening of the injector, and from the time interval d3 necessary for the mechanical closing of the injector, according to the equation d=d1−d2+d3.

17. The device as claimed in claim 2, characterized in that it comprises
a sensor (11) for measuring the fuel pressure in said fuel feed circuit (7),
means (12) for making a comparison between the value for measuring the fuel pressure taken by said sensor (11) and said reconstituted fuel pressure value and
means (3) for making a diagnosis of the operating status of said pressure sensor (11) from the result of said comparison.

18. The device as claimed in claim 3, characterized in that it comprises
a sensor (11) for measuring the fuel pressure in said fuel feed circuit (7),
means (12) for making a comparison between the value for measuring the fuel pressure taken by said sensor (11) and said reconstituted fuel pressure value and
means (3) for making a diagnosis of the operating status of said pressure sensor (11) from the result of said comparison.
